(19) United States
(12) Patent Application Publication
(10) Pub. No.: US 2004/0247964 A1
(43) Pub. Date: Dec. 9, 2004

(54) Protection circuit for fuel cell and fuel cell with the same

(75) Inventors: Atsushi Sadamoto, Kawasaki-shi (JP); Nobuo Shibuya, Hiratsuka-shi (JP); Norihiro Tomimatsu, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/811,935

(22) Filed: Mar. 30, 2004

(30) Foreign Application Priority Data
Mar. 31, 2003 (JP) 2003-096423

(51) Int. Cl. H01M 8/04

(52) U.S. Cl. 429/23

(57) ABSTRACT

A fuel cell system is provided with a fuel cell stack including plural unit fuel cells connected in series, plural detection units respectively detecting abnormality of potential differences between the positive and negative electrodes of unit fuel cells, the unit fuel cells being connected in series and constituting a part of the fuel cell stack and a bypass unit forming bypass current path between the ends, the bypass unit being operative when at least one of the plural detection units detects the abnormality of the potential difference.

### CROSS-REFERENCE TO RELATED APPLICATIONS

This application is based upon and claims the benefit of priority from the prior Japanese Patent Application No. 2003-096423 (filed Mar. 31, 2003); the entire contents of which are incorporated herein by reference.

### BACKGROUND OF THE INVENTION

1. Field of the Invention

The present invention relates to a protection circuit for a fuel cell and a fuel cell with a protection circuit, which are preferably applied to mobile and portable electronic equipments such as an office-automation equipment and a communication equipment.

2. Description of the Related Art

A direct methanol fuel cell (“DMFC” hereinafter) generally constituted is provided with a pair of electrodes, each of which is composed of a catalytic layer and carbon paper, and an electrolyte film put therebetween. A set of the electrodes and the electrolyte film is named as a membrane electrode assembly (“MEA” hereinafter). The MEA is further put between separators, which are plate-like bodies and are provided with flow paths, to form a fuel cell. Fuel (methanol in this case) is supplied to one of the electrodes and air is supplied to the other of the electrodes by means of the flow paths. Packing seals are respectively provided between the separators and the electrolyte film for preventing fuel and air leakage. The separators are generally formed of conductive materials so that electric power is extracted through the separators. A fixation structure for fixing whole of the cell structure is provided at an outside of the cell structure.

In general, two or more sets of the fuel cells are stacked to form a fuel cell stack to multiply so that larger electric power is extracted. In this case, the fixation structure is formed so as to fix whole of the stack structure. Each of the pair of separators adjacent to each other in the stack structure are formed into an integral body so that the structure is simply and compactly constituted. Namely, each of the integrated separators is provided with two sets of flow paths formed on both sides thereof, one is for supplying air and the other is for supplying fuel. In this case, generated current flows from one cell to the other cell via the separator put therebetween.

As mentioned above, the fuel cells of the fuel cell stack are connected in series via the separators. Voltage generated by the respective fuel cells is multiplied by the number of the fuel cells and is hence output.

However, provided that one of the fuel cells malfunctions caused by any factor such as shortage of fuel supply, the voltage generated by the malfunctioning fuel cell is lost, moreover, the malfunctioning fuel cell functions as a resistance against current generated by the other fuel cells. This leads to relatively large voltage reduction. Furthermore, reverse voltage, which is reverse to generating voltage in a normal operation, is applied to the malfunctioning fuel cell during the malfunction. Therefore, if the malfunctioning fuel cell failed to immediately recover to a normal operation, the MEA therein might be damaged and then the malfunctioning fuel cell might continue to be a load as a resistance to the other fuel cells in the fuel cell stack. This leads to reduction of electric power generation.

### SUMMARY OF THE INVENTION

The present invention is achieved in view of the above problem and intended for providing a fuel cell and a protection circuit therefor which effectively prevents damage on the MEA when malfunction occurs.

According to a first aspect of the invention, a protection circuit for a fuel cell stack having one or more fuel cells is provided with a detection unit detecting abnormality of a potential difference between positive and negative electrodes of at least one fuel cell of the fuel cell stack and a bypass unit forming bypass current path between the positive and negative electrodes, the bypass unit being operative when the detection unit detects the abnormality of the potential difference.

According to a second aspect of the invention, a fuel cell system is provided with a fuel cell stack; a detection unit detecting abnormality of a potential difference between positive and negative electrodes of at least one unit fuel cell of the fuel cell stack; and a bypass unit forming bypass current path between the positive and negative electrodes, the bypass unit being operative when the detection unit detects the abnormality of the potential difference.

According to a third aspect of the invention, a fuel cell system is provided with a fuel cell stack; a detection unit detecting abnormality of a potential difference between both ends of at least one series of plural unit fuel cells, the plural unit fuel cells being connected in series and constituting a part of the fuel cell stack; and a bypass unit forming bypass current path between the ends, the bypass unit being operative when the detection unit detects the abnormality of the potential difference.

According to a fourth aspect of the invention, a fuel cell system is provided with a fuel cell stack; plural detection units respectively detecting abnormality of potential differences between the positive and negative electrodes of plural unit fuel cells, the plural unit fuel cells being connected in series and constituting a part of the fuel cell stack; and a bypass unit forming bypass current path between both ends of the series of the plural unit fuel cells, the bypass unit being operative when at least one of the plural detection units detects the abnormality of the potential difference.

### BRIEF DESCRIPTION OF THE DRAWINGS

FIGS. 1A through 1F are versions of connection between a protection circuit and a fuel cell stack;

FIG. 2 is a schematic diagram of a protection circuit according to an embodiment of the present invention;

FIG. 3 is a schematic diagram of a protection circuit according to another embodiment of the present invention;

FIG. 4 is a partly-shown flow chart of a version for operating a fuel cell system to which any of the protection circuits of FIGS. 2 and 3 is applied;

FIG. 5 is a partly-shown flow chart of another version for operating a fuel cell system to which any of the protection circuits of FIGS. 2 and 3 is applied;

FIG. 6 is a schematic diagram of a protection circuit according to still another embodiment of the present invention;

FIG. 7 is a schematic diagram of a protection circuit according to yet another embodiment of the present invention;

FIG. 8 is a partly-shown flow chart of a version for operating a fuel cell system to which any of the protection circuits of FIGS. 6 and 7 is applied;

FIG. 9A is a schematic illustration of a fuel cell stack of a bipolar type;

FIG. 9B is a cross sectional view of an example of a separator for the fuel cell stack of FIG. 9A;

FIG. 10A is a schematic illustration of a fuel cell stack of a bipolar type according to a modified embodiment;

FIG. 10B is a cross sectional view of a projected portion of a separator for the fuel cell stack of FIG. 10A;

FIG. 11A is a schematic illustration of a fuel cell stack of a monopolar type;

FIG. 11B is a cross sectional view of an example of a separator for the fuel cell stack of FIG. 11A;

FIGS. 12A through 12C are schematic illustrations of fuel cell systems according to a first embodiment of the present invention;

FIGS. 13A through 13C are schematic illustrations of fuel cell systems according to a second embodiment of the present invention;

FIGS. 14A through 14C are schematic illustrations of fuel cell systems according to a third embodiment of the present invention;

FIGS. 15A through 15C are schematic illustrations of fuel cell systems according to a fourth embodiment of the present invention;

FIGS. 16A through 16C are schematic illustrations of fuel cell systems according to a fifth embodiment of the present invention; and

FIGS. 17A through 17C are schematic illustrations of fuel cell systems according to a sixth embodiment of the present invention.

### DETAILED DESCRIPTION OF THE INVENTION

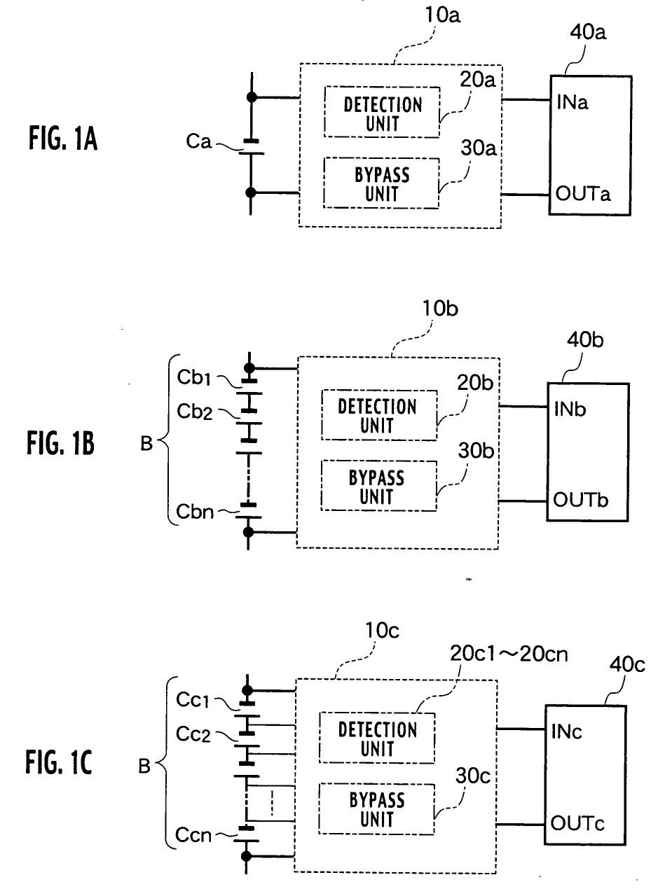

Circuit diagrams of a protection circuit and a fuel cell stack according to embodiments of the present invention will be described hereinafter with reference to FIGS. 1A-1F.

Referring is now made to FIG. 1A. A protection circuit 10a is connected to a unit fuel cell Ca, which is one of fuel cells constituting a fuel cell stack, in parallel. The protection circuit 10a is provided with a detection unit 20a for detecting abnormality of a potential difference between positive and negative electrodes of the unit fuel cell Ca and a bypass unit 30a having bypass current path for bypassing current from the unit fuel cell Ca thereto when the abnormality of the potential difference is detected by the detection unit 20a. The bypass unit 30a short-circuits the positive and negative electrodes of the unit fuel cell Ca to form the bypass current path. The detection unit 20a and the bypass unit 30a are controlled by a system controller 40a.

Referring is now made to FIG. 1B. A protection circuit 10b is connected to one or more unit fuel cells Cb₁, Cb₂, Cb₃ . . . , which are connected in series (a series cell set B) and constitute a part of a fuel cell stack, in parallel. Similarly to the above constitution shown in FIG. 1A, the protection circuit 10b is provided with a detection unit 20b and a bypass unit 30b. However, the detection unit 20b detects abnormality of a potential difference between both end electrodes of the series cell set B and the bypass unit 30b short-circuits the end electrodes of the series cell set B to form the bypass current path. The detection unit 20b and the bypass unit 30b are controlled by a system controller 40b.

Referring is now made to FIG. 1C. A protection circuit 10c is connected to one or more unit fuel cells Cc₁, Cc₂, Cc₃ . . . , which are connected in series (a series cell set B) and constitute apart of a fuel cell stack, in parallel. The protection circuit 10c is provided with a plurality of detection units 20c and a bypass unit 30c. The detection units 20c respectively detect abnormality of potential differences concerning with the respective unit fuel cells Cc₁, Cc₂, Cc₃ . . . The bypass unit 30c is provided similarly to the above constitution, however, is configured to form a bypass current path when at least one of the unit fuel cells Cc₁, Cc₂, CC₃ . . . indicates the abnormality of the potential difference. The bypass unit 30c short-circuits the end electrodes of the series cell set B to form the bypass current path. The detection units 20c and the bypass unit 30c are controlled by a system controller 40c.

Referring is now made to FIG. 1D. Similarly to the above constitution shown in FIG. 1A, a protection circuit 10d is connected to a unit fuel cell Cd, which is one of fuel cells constituting a fuel cell stack, in parallel and is provided with a detection unit 20d and a bypass unit 30d. However, the bypass unit 30d is configured to electrically separate the unit fuel cell Cd from the fuel cell stack when the detection unit 20d detects abnormality of a potential difference between the positive and negative electrodes of the unit fuel cell Cd. The detection unit 20d and the bypass unit 30d are controlled by a system controller 40d.

Referring is now made to FIG. 1E. Similarly to the above constitution shown in FIG. 1B, a protection circuit 10e is connected to one or more unit fuel cells Ce₁, Ce₂, Ce₃ . . . , which are connected in series (a series cell set B) and constitute a part of a fuel cell stack, in parallel and is provided with a detection unit 20e and a bypass unit 30e. The detection unit 20e detects abnormality of a potential difference between both end electrodes of the series cell set B and then the bypass unit 30e forms a bypass current path. However, the bypass unit 30e is configured to electrically separate the series cell set B from the fuel cell stack to form the bypass current path when the detection unit 20e detects the abnormality of the potential difference. The detection unit 20e and the bypass unit 30e are controlled by a system controller 40e.

Referring is now made to FIG. 1F. Similarly to the above constitution shown in FIG. 1C, a protection circuit 10f is connected to one or more unit fuel cells Cf₁, Cf₂, Cf₃ . . . , which are connected in series (a series cell set B) and constitute apart of a fuel cell stack, in parallel. The protection circuit 10f is provided with a plurality of detection units 20f and a bypass unit 30f. The detection units 20f respectively detect abnormality of potential differences concerning with the respective unit fuel cells Cf₁, Cf₂, Cf₃ . . . and then the bypass unit 30f forms a bypass current path. However, the bypass unit 30f is configured to electrically separate the series cell set B from the fuel cell stack to form the bypass current path when at least one of the unit fuel cells Cf₁, Cf₂, Cf₃ . . . indicates the abnormality of the potential difference. The detection units 20f and the bypass unit 30f are controlled by a system controller 40f.

Any of the detection units 20a-20f (representatively denoted by 20 hereinafter) is configured to measure a potential difference between the positive and negative electrodes of a particular unit fuel cell C or both the end electrodes of the series cell set B and compare a predetermined threshold value thereto. The detection unit 20 detects a matter that the measured potential difference goes below the threshold value as the abnormality of the potential difference, that is to say, a power generation malfunction. Therefore, the detection unit 20 is configured to be able to at least detect potential reversal of the fuel cell as the power generation malfunction and preferably detect the fact that the measured potential difference goes below the threshold value as the power generation malfunction.

Any of the bypass units 30a-30c (representatively denoted by 30 in this paragraph) is configured to short-circuit positive and negative electrodes of a unit fuel cell C or both end electrodes of a series cell set B when the detection unit 20 detects abnormality of a potential difference thereof. For short-circuiting, the bypass unit 30 is provided with a switching circuit which is opened in a steady state and closed when detecting the abnormality of the potential difference.

Any of the bypass units 30d-30f (representatively denoted by 30 in this paragraph) is configured to electrically separate a unit fuel cell C or a series cell set B when the detection unit 20 detects abnormality of a potential difference thereof. For separating, the bypass unit 30 is provided with a first switching circuit connected to the unit fuel cell C or the series cell set B in series and a second switching circuit connected to both ends of the series connection between the unit fuel cell C or the series cell set B and the first switching circuit in parallel. In a steady state, the first switching circuit is closed and the second switching circuit is opened. On the contrary, when detecting the abnormality of the potential difference, the first switching circuit is opened and the second switching circuit is closed.

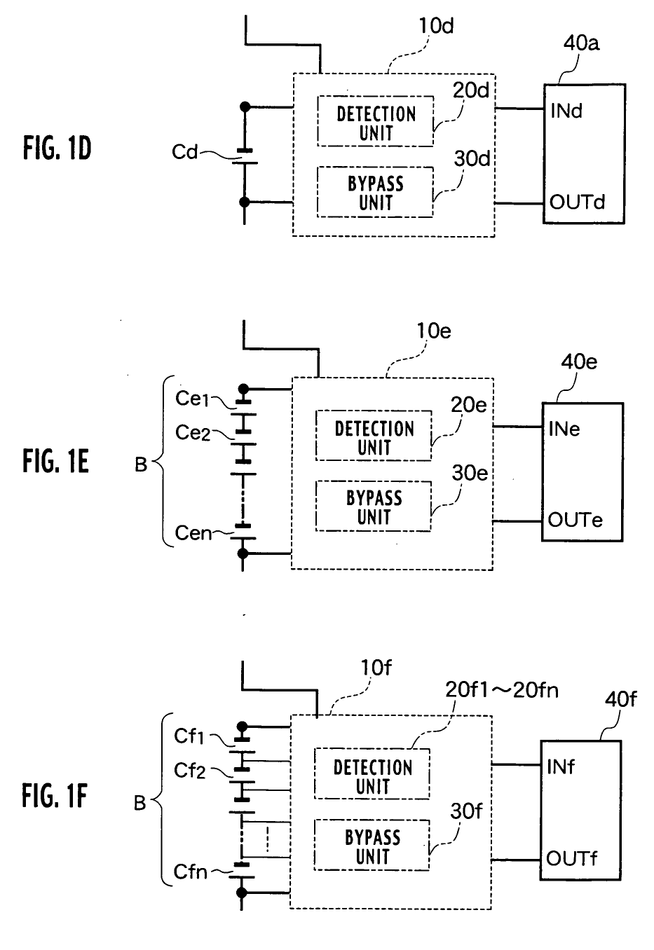

A protection circuit 11 according to an embodiment of the present invention will be described hereinafter as an example of the above protection circuit 10 with reference to FIG. 2. The protection circuit 11 has a function of protection of a MEA of a fuel cell when malfunction occurs by means of short-circuiting positive and negative electrodes of the fuel cell.

In the protection circuit 11, a detection unit 20 is provided with a comparator IC 21, which compares a voltage to a predetermined value, so as to detect abnormality of a potential difference of the unit fuel cell C to which the protection circuit 11 is connected. A bypass unit 30 is provided with a p-channel power FET switching device 31 which is connected to the unit fuel cell C in parallel and a level conversion driver 32 for switching the power FET switching device 31. The level conversion driver 32 is configured to switch the power FET switching device 31 On/Off so as to short-circuit positive and negative electrodes of the unit fuel cell C, both the electrodes of which are at positive potential, and is provided with a p-channel FET switching device 32a and an n-channel FET switching device 32b. The protection circuit 11 can be connected to any of the unit fuel cells C constituting a fuel cell stack. The system controller 40 is provided with a micro-controller 41 for control.

When potential reversal happens at the unit fuel cell C, the comparator IC 21 detects the potential reversal and output a detection signal of a logic level to an IN port of the micro-controller 41. The micro-controller 41 receives the detection signal from the comparator IC 21 and switch an output level of an OUT port from High to Low. By means of switching of the output level, respective switching devices 32a and 32b of the level conversion driver 32 are switched on and thereby the power FET switching device 31 becomes a low impedance state so as to be switched on. Thereby the positive and negative electrodes of the unit fuel cell C are short-circuited so that current of the fuel cell stack bypasses the unit fuel cell C and flows through the power FET device 31.

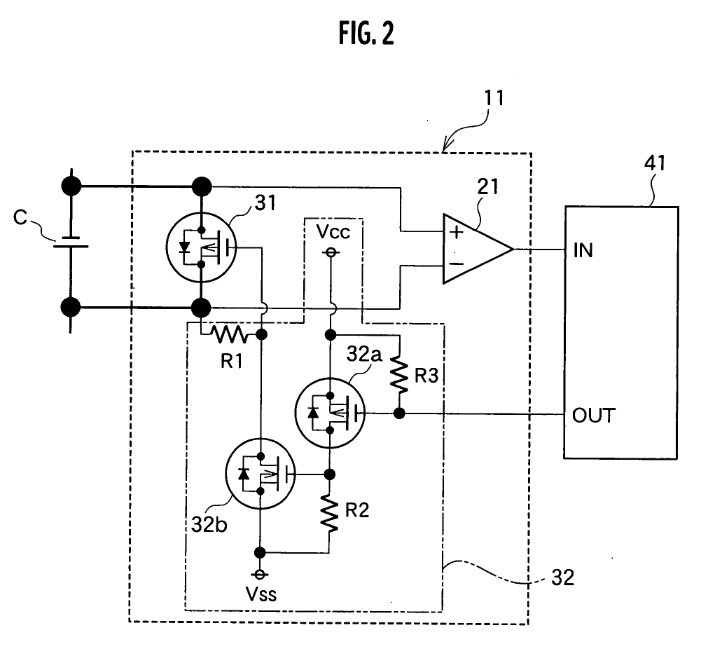

A protection circuit 12 according to another embodiment of the present invention will be described hereinafter as another example of the above protection circuit 10 with reference to FIG. 3. In this case, one of the electrodes of the unit fuel cell C is grounded to be a grounding electrode GND.

In the protection circuit 12, a bypass unit 30 is provided with a power (n-channel in this case) FET switching device 31 connected to the unit fuel cell C in parallel. As compared with the aforementioned protection circuit 11, a level conversion driver 32 can be omitted so that the present protection circuit 12 can be more simply constituted. A detection unit 20 is provided with a comparator IC 21 and a system controller 40 is provided with a micro-controller 41.

When potential reversal happens at the unit fuel cell C, the comparator IC 21 detects the potential reversal and output a detection signal of a logic level to an IN port of the micro-controller 41. The micro-controller 41 receives the detection signal from the comparator IC 21 and switch an output level of an OUT port from a high level to a low level. By means of switching of the output level, the power FET switching device 31 becomes a low impedance state so as to be switched on. Thereby the positive and negative electrodes of the unit fuel cell C are short-circuited so that current of the fuel cell stack bypasses the unit fuel cell C and flows through the power FET device 31.

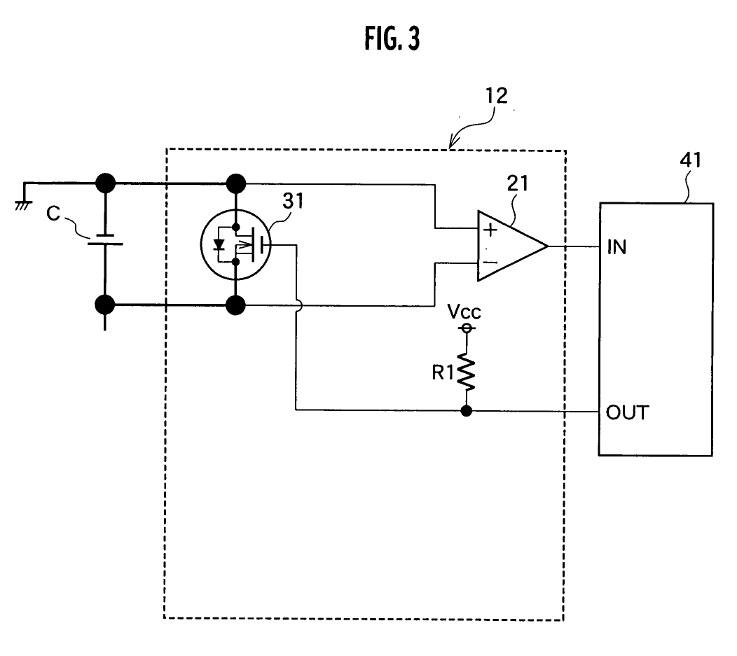

Referring is now made to FIG. 4 showing a flow chart for operating the fuel cell system employing the protection circuit 11 shown in FIG. 2 or protection circuit 12 shown in FIG. 3. In the case of the protection circuit 11 or 12 for the fuel cell system, the detection unit 20 is assumed to have functions of not only detecting potential reversal of the fuel cell as the power generation malfunction but also detecting the fact that the measured potential difference goes below the threshold value as the power generation malfunction.

FIG. 4 reflects only apart concerning with the protection circuits 11 and 12 among a flow chart of operation of the fuel cell system and therefore does not show the other processes. The processes shown in the part should be inserted into a control loop of the fuel cell system. For example, the processes are repeated in a control cycle of about several seconds duration during the operation of the fuel cell system. The other processes omitted in FIG. 4 include a scanning in a case where a single fuel cell is provided with a plurality of protection circuits 11 or 12.

First, as shown in FIG. 4, it is judged if a potential difference between the positive and negative electrodes of the unit fuel cell C to which the protection circuit 11 or 12 is connected goes beyond a predetermined threshold voltage (a step S11). If the potential difference is beyond the threshold voltage (judging YES at the step S11), the operation is judged to be normal and moves to a next process (a step S12) after waiting a predetermined period of time T1.

If the potential difference is below the threshold voltage (judging NO at the step S11), it is judged to be a malfunction of power generation of the unit fuel cell C and the circuit of the bypass unit is closed (a step S13). After waiting a predetermined period of time T2 (a step S14), the circuit of the bypass unit is opened (a step S15). Further after waiting a predetermined period of time T3 (a step S16), a potential difference between the positive and negative electrodes of the unit fuel cell C is compared with the threshold voltage and it is judged whether normal or abnormal (a step S17).

IF the potential difference between the positive and negative electrodes of the unit fuel cell C is beyond the threshold voltage (YES at the step S17), malfunction of the unit fuel cell C is regarded as being recovered and the operation moves to the next process (a step S12) after waiting the predetermined period of time T1.

On the contrary, if the potential difference between the positive and negative electrodes of the unit fuel cell C is kept below the threshold voltage (NO at the step S17), the operation goes back to the step S13 and the circuit of the bypass unit is closed. If repetition of the step S17 and the step S13 is repeatedly done in several times concerning with the particular unit fuel cell C, the malfunction thereof can be regarded as being unrecoverable for the moment and therefore the circuit of the bypass unit may be configured to be kept closed (the step S13). In a case where a plurality of, or all of, the unit fuel cells C are respectively provided with the protection circuits 11 or 12 and such repetition is repeated in several times concerning with a considerable number of the unit fuel cells C, for example, ⅓ of the whole of the unit fuel cells C, the life of the fuel cells can be regarded as running out and therefore the fuel cell system may be configured to be stopped.

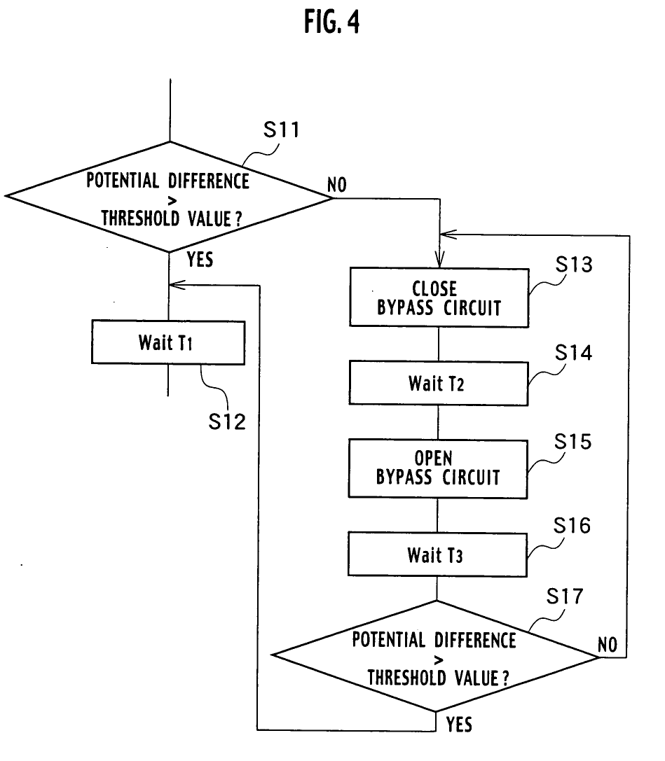

FIG. 5 shows an alternative example, in which recovery processes after short-circuiting the malfunctioning fuel cell are omitted. Though short-circuiting the malfunctioning fuel cell leads to voltage reduction of the fuel cell stack, damage to the malfunctioning fuel cell, particularly to the MEA therein, can be prevented and the fuel cell stack can be employed with opening the circuit of the bypass unit again.

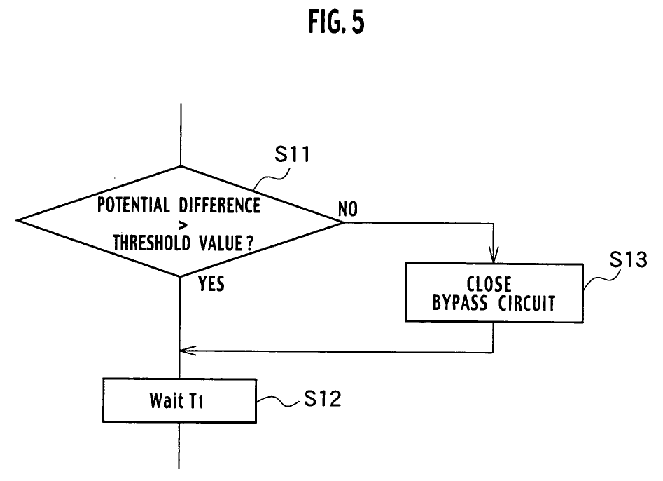

A protection circuit 13 according to still another embodiment of the present invention will be described hereinafter as the still another example of the above protection circuit 10 with reference to FIG. 6. The protection circuit 13 has a function of protection of a MEA of a fuel cell when malfunction occurs by means of electrically separating the malfunctioning fuel cell from the fuel cell stack, instead of short-circuiting the malfunctioning fuel cell.

In the protection circuit 13, a detection unit 20 is provided with a comparator IC 21, which compares a voltage to a predetermined value, so as to detect abnormality of a potential difference of the unit fuel cell C to which the protection circuit 13 is connected. A bypass unit 30 is provided with a p-channel power FET switching device 33 which is connected to the unit fuel cell C in series, a level conversion driver 34 for switching the power FET switching device 33, a p-channel power FET switching device 35 which is connected to both ends of the series circuit of the unit fuel cell C and the power FET switching device 33 and a level conversion driver 36 for switching the power FET switching device 35. The level conversion drivers 34 and 36 are configured to switch the power FET switching devices 33 and 35 On/Off, both drains and sources of which are in positive potential. The level conversion driver 34 is provided with an n-channel FET switching device 34a, a p-channel FET switching device 34b and an n-channel FET switching device 34c. The level conversion driver 36 is provided with a p-channel FET switching device 36a and an n-channel FET switching device 36b. Thereby the protection circuit 13 may be connected to any of the unit fuel cells C constituting a fuel cell stack. A system controller 40 is provided with a micro-controller 41 for control.

When potential reversal happens at the unit fuel cell C, the comparator IC 21 detects the potential reversal and output a detection signal of a logic level to an IN port of the micro-controller 41. The micro-controller 41 receives the detection signal from the comparator IC 21 and switch an output level of an OUT port from a high level to a low level. By means of switching of the output level, the respective switching devices 34a, 34b and 34c of the level conversion driver 34 are switched off and thereby the power FET switching device 31 is switched off (separating). At the same time, the switching devices 36a and 36b of the level conversion driver 36 are switched on and thereby the power FET switching device 35 becomes a low impedance state so as to be switched on. Thereby the unit fuel cell C is electrically separated from the fuel cell stack and current of the fuel cell stack bypasses the unit fuel cell C and flows through the power FET device 35.

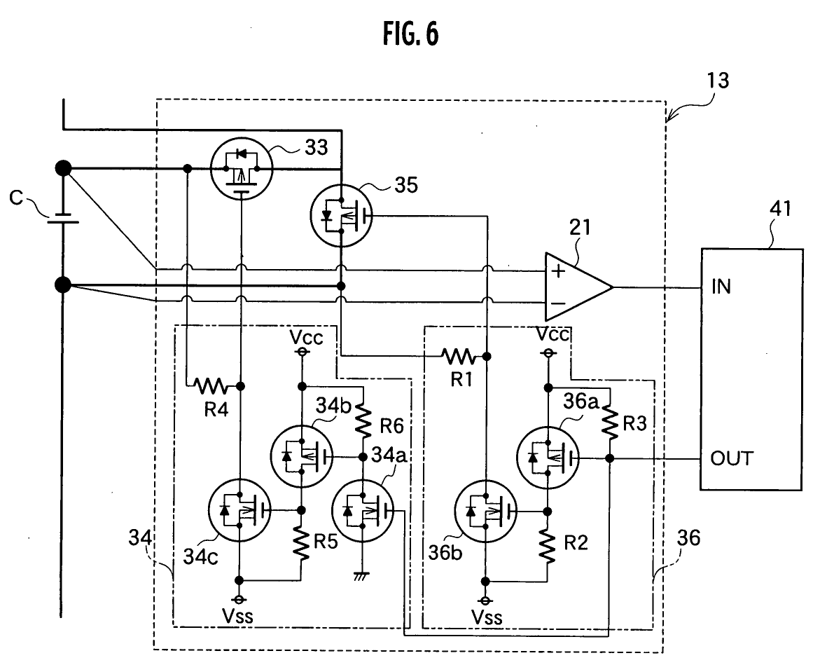

A protection circuit 14 according to yet another embodiment of the present invention, shown in FIG. 7, can be applied to a case where one of electrodes of the unit fuel cell C is in a GND level. The protection circuit 14 functions as a changeover switch for changing a GND electrode of a fuel cell stack from a malfunctioning fuel cell disposed at an end of the fuel cell stack to a next unit fuel cell when malfunction occurs.

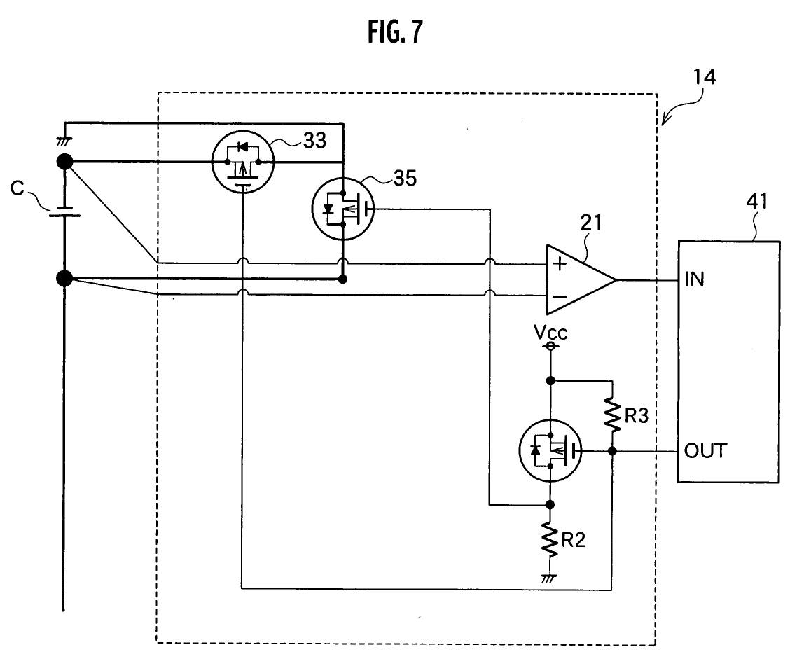

Referring is now made to FIG. 8 showing a flow chart for operating the fuel cell system employing the protection circuit 13 shown in FIG. 6 or the protection circuit 14 shown in FIG. 7. In the case of the protection circuit 13 or 14, as similar with the flow chart shown in FIG. 4, the detection unit 20 is assumed to have functions of not only detecting potential reversal of the fuel cell as the power generation malfunction but also detecting the fact that the measured potential difference goes below the threshold value as the power generation malfunction. FIG. 8 reflects only a part concerning with the protection circuits 13 and 14.

First, as shown in FIG. 8, it is judged if a potential difference between the positive and negative electrodes of the unit fuel cell C to which the protection circuit 13 or 14 is connected goes beyond a predetermined threshold voltage (a step S21). If the potential difference is beyond the threshold voltage (judging YES at the step S21), the operation is judged to be normal and moves to a next process (a step S22) after waiting a predetermined period of time T1.

If the potential difference is below the threshold voltage (judging NO at the step S21), it is judged to be a malfunction of power generation of the unit fuel cell C and the input level (the output level of the OUT1) of the bypass unit is switched from High to Low (a step S23). After waiting a predetermined period of time T3 (a step S26), a potential difference between the positive and negative electrodes of the unit fuel cell C is compared with the threshold voltage and it is judged whether normal or abnormal (a step S27).

If the potential difference between the positive and negative electrodes of the unit fuel cell C is beyond the threshold voltage (YES at the step S27), malfunction of the unit fuel cell C is regarded as being recovered and the operation moves to the next step (a step S22) after waiting the predetermined period of time (T1).

On the contrary, if the potential difference between the positive and negative electrodes of the unit fuel cell C is kept below the threshold voltage (NO at the step S27), the operation goes back to the step S23 and the input level of the bypass unit is switched from High to Low. If repetition of the step S27 and the step S23 is repeatedly done in several times concerning with the particular unit fuel cell C, the malfunction thereof can be regarded as being unrecoverable for the moment and therefore the input level of the bypass unit may be configured to be kept Low (the step S23). In a case where a plurality of, or all of, the unit fuel cells C are respectively provided with the protection circuits 11 or 12 and such repetition is repeated in several times concerning with a considerable number of the unit fuel cells C, for example, ⅓ of the whole of the unit fuel cells C, the life of the fuel cells can be regarded as running out and therefore the fuel cell system may be configured to be stopped.

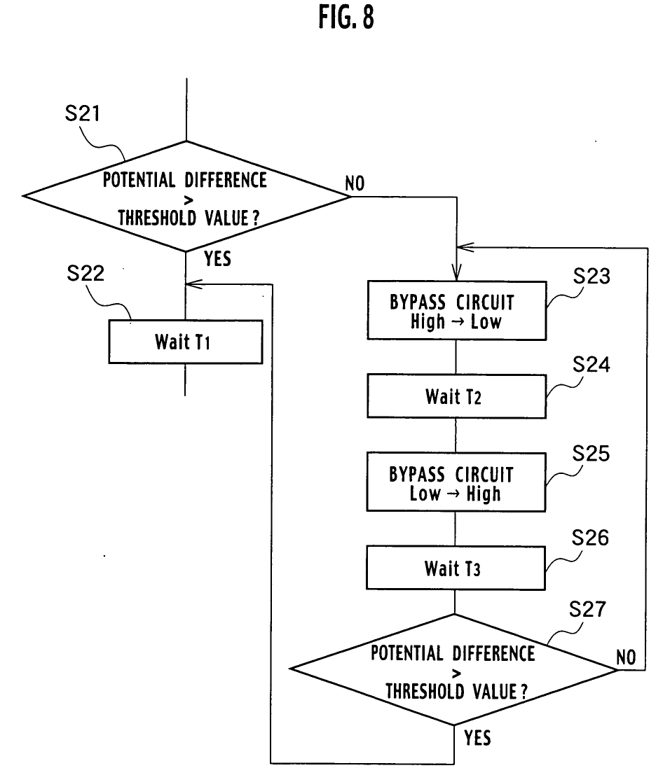

Among the aforementioned protection circuits 11 through 14, the protection circuits 11 and 12 shown in FIGS. 2 and 3 have a function of short-circuiting the malfunctioning fuel cell and therefore can be applied to a bipolar type fuel cell stack shown in FIG. 9A. The bipolar type fuel cell stack is provided with separators as shown in FIG. 9B, each of which has flow paths on both sides and serves as both a structural support and a conductor for fuel cells disposed on the both sides.

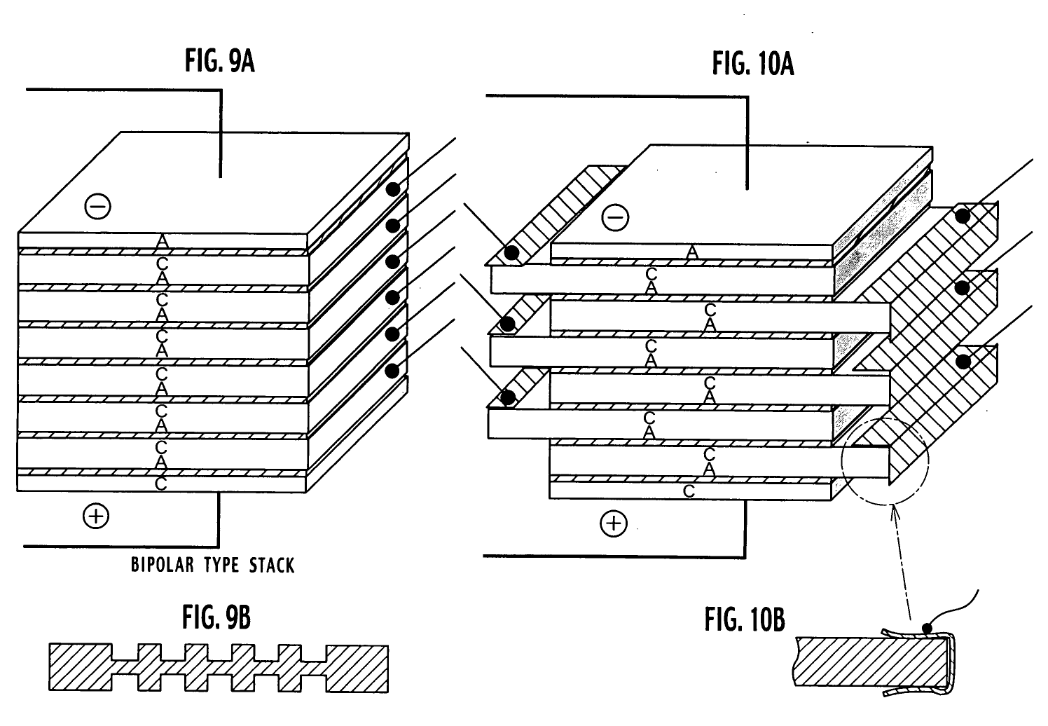

For connecting the protection circuits, lead wires are connected to the ends of the respective separators as shown in FIG. 9A. However, particularly in a case where the separators are formed in an extremely thin form for miniaturization, voltage drop caused by resistance between the lead wire and the separator may be nonnegligible relative to the cell voltage. In such a case, the separators may be accumulated in a staggered manner as shown in FIG. 10A. and thus projected portions of the separators may be provided with metal fittings each formed in an U-clip as shown in FIG. 10B for connecting to the lead wires so as to have enough contact area.

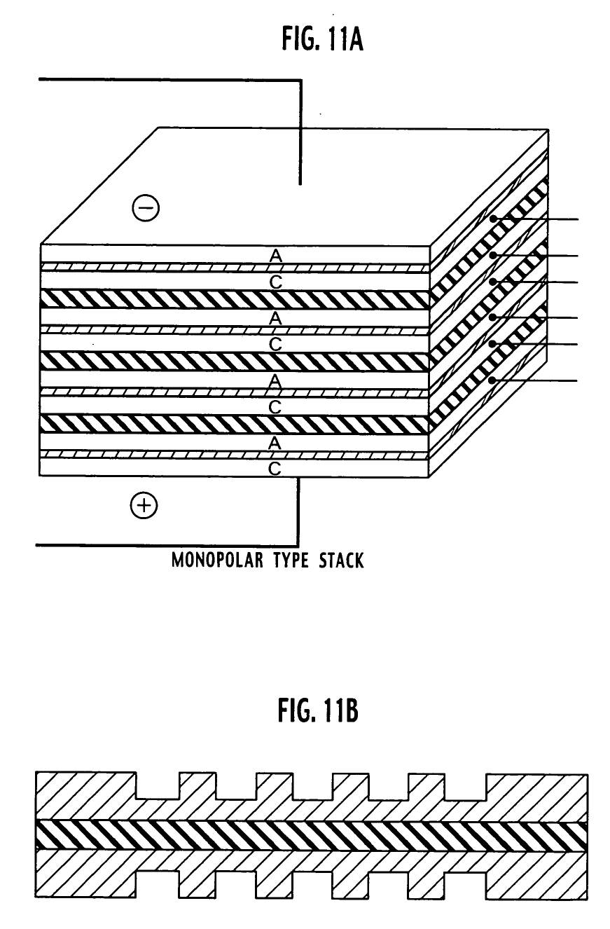

On the contrary, the protection circuits 13 and 14 shown in FIGS. 6 and 7 have a function of electrically separating the malfunctioning fuel cell from the fuel cell stack and hence can be applied to a monopolar type fuel cell stack shown in FIG. 11A. The monopolar type fuel cell stack is provided with separators as shown in FIG. 11B, each of which has flow paths on only one side thereof. The respective unit fuel cells are electrically separated from each other. However, even in a case of the fuel cell stack shown in FIG. 9A or 10A, the protection circuits 13 and 14 can be applied limitedly to fuel cells disposed at ends thereof.

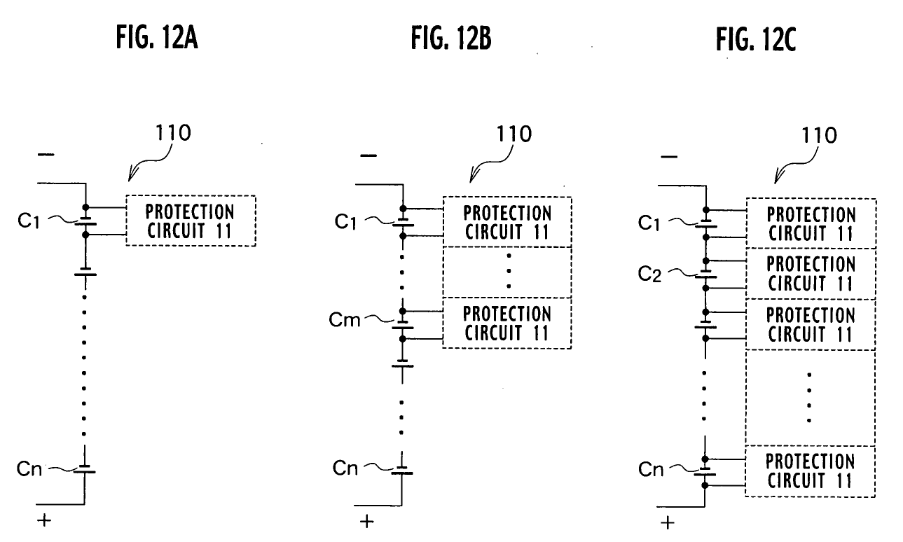

FIGS. 12A through 17C schematically illustrate certain embodiments of the fuel cell provided with any of the aforementioned protection circuits 11 through 14.

FIGS. 12A through 12C show schematic diagrams of fuel cell systems 110 according to a first embodiment of the present invention. As shown in FIG. 12A, the system can be configured so that the diagram the protection circuit 11 is connected to only one unit fuel cell C₁ at a negative end of unit fuel cells C₁, C₂, . . . Cₙ constituting the fuel cell stack. Alternatively, the system can be configured so that the protection circuits 11 are respectively connected to first to m-th unit fuel cells C₁, C₂, . . . Cₘ from the negative end among the unit fuel cells C₁, C₂, . . . Cₙ, where m can be arbitrarily selected, as shown in FIG. 12B. Further alternatively, the system can be configured so that the protection circuits 11 are respectively connected to all of the unit fuel cells C₁, C₂, . . . Cₙ constituting the fuel cell stack as shown in FIG. 12C.

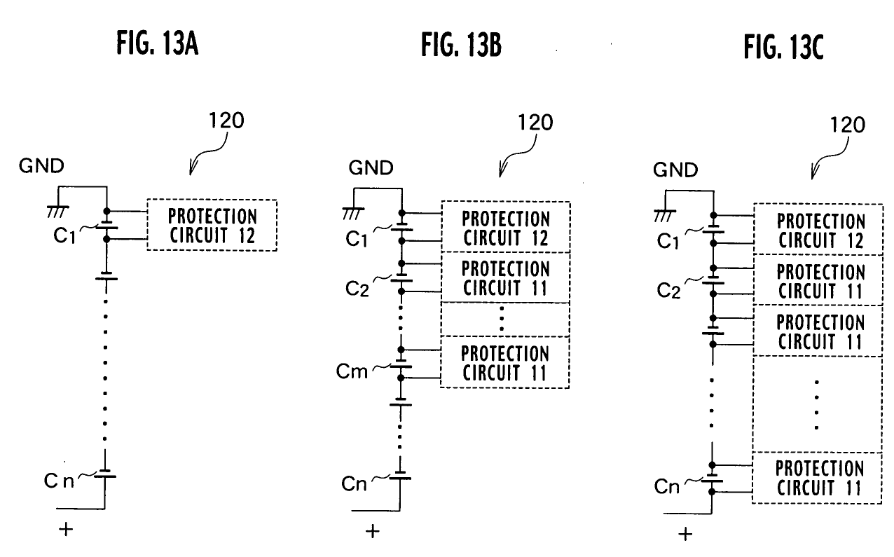

FIG. 13A through 13C show schematic drawings of fuel cell systems 120 according to a second embodiment of the present invention. According to FIG. 13A, the system can be configured so that the protection circuit 12 is connected to only one unit fuel cell C₁ at a negative end of unit fuel cells C₁, C₂, . . . Cₙ constituting the fuel cell stack. Alternatively, the system can be configured so that the protection circuit 12 is connected to the unit fuel cell C₁ and the protection circuits 11 are respectively connected to second to m-th unit fuel cells C₂, C₃, . . . Cₘ, among the unit fuel cells C₁, C₂, . . . Cₙ where m can be arbitrarily selected, as shown in FIG. 13B. Further alternatively, the system can be configured so that the protection circuit 12 is connected to the unit fuel cell C₁ and the protection circuits 11 are respectively connected to all the unit fuel cells C₂, C₃, . . . Cₙ except C₁ disposed at the negative end as shown in FIG. 13C.

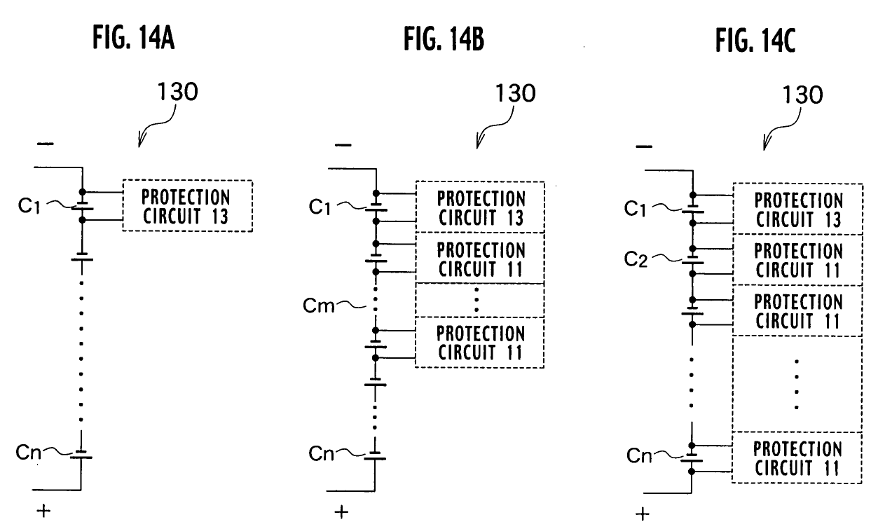

FIG. 14A through 14C show schematic drawings of fuel cell systems 130 according to a third embodiment of the present invention. According to FIG. 14A, the system can be configured so that the protection circuit 13 is connected to only one unit fuel cell C₁ at a grounded end of unit fuel cells C₁, C₂, . . . Cₙ constituting the fuel cell stack. Alternatively, the system can be configured so that the protection circuit 13 is connected to the unit fuel cell C₁ and the protection circuits 11 are respectively connected to second to m-th unit fuel cells C₂, C₃, . . . Cₘ, among the unit fuel cells C₁, C₂, . . . Cₙ where m can be arbitrarily selected, as shown in FIG. 14B. Further alternatively, the system can be configured so that the protection circuit 13 is connected to the unit fuel cell C₁ and the protection circuits 11 are respectively connected to all the unit fuel cells C₂, C₃, . . . Cₙ except C₁ disposed at the grounded end as shown in FIG. 14C.

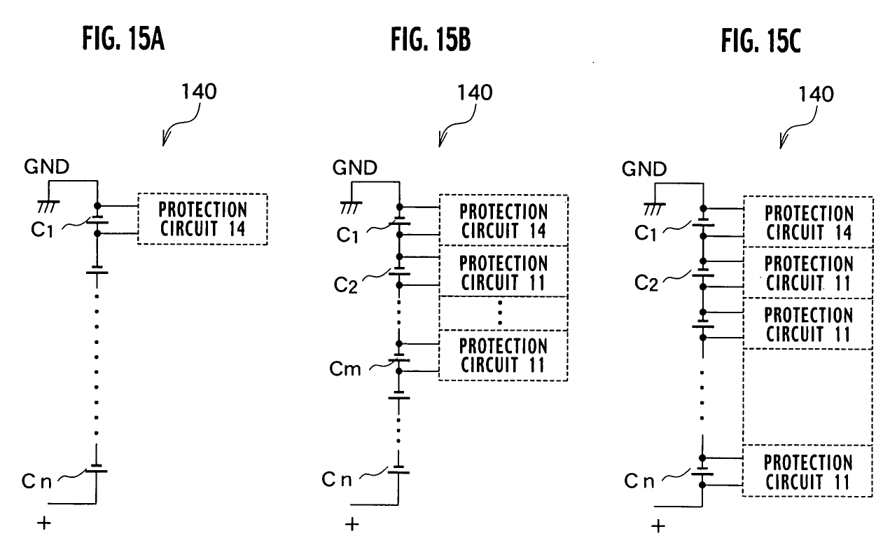

FIG. 15A through 15C show schematic drawings of fuel cell systems 140 according to a fourth embodiment of the present invention. According to FIG. 15A, the system can be configured so that the protection circuit 14 is connected to only one unit fuel cell C₁ at a grounded end of unit fuel cells C₁, C₂, . . . Cₙ constituting the fuel cell stack. Alternatively, the system can be configured so that the protection circuit 14 is connected to the unit fuel cell C₁ and the protection circuits 11 are respectively connected to second to m-th unit fuel cells C₂, C₃, . . . Cₘ, among the unit fuel cells C₁, C₂, . . . Cₙ where m can be arbitrarily selected, as shown in FIG. 15B. Further alternatively, the system can be configured so that the protection circuit 14 is connected to the unit fuel cell C₁ and the protection circuits 11 are respectively connected to all the unit fuel cells C₂, C₃, . . . Cₙ except C₁ disposed at the grounded end as shown in FIG. 15C.

Because any of the fuel cell systems 110, 120, 130 and 140 short-circuits a malfunctioning fuel cell, the aforementioned bipolar type fuel cell stack shown in FIG. 9A can be applied thereto.

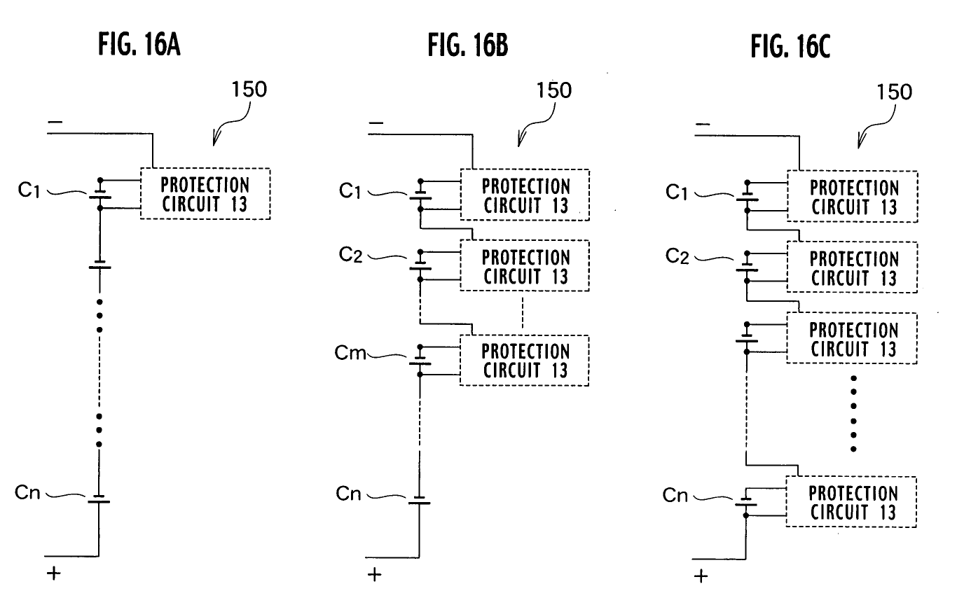

FIGS. 16A through 16C show schematic diagrams of fuel cell systems 150 according to a fifth embodiment of the present invention. As shown in FIG. 16A, the system can be configured so that the protection circuit 13 is connected to only one unit fuel cell C₁ at a negative end of unit fuel cells C₁, C₂, . . . Cₙ constituting the fuel cell stack. Alternatively, the system can be configured so that the protection circuits 13 are respectively connected to first to m-th unit fuel cells C₁, C₂, . . . Cₘ from the negative end among the unit fuel cells C₁, C₂, . . . C₁, where m can be arbitrarily selected, as shown in FIG. 16B. Further alternatively, the system can be configured so that the protection circuits 13 are respectively connected to all of the unit fuel cells C₁, C₂, . . . Cₙ constituting the fuel cell stack as shown in FIG. 16C.

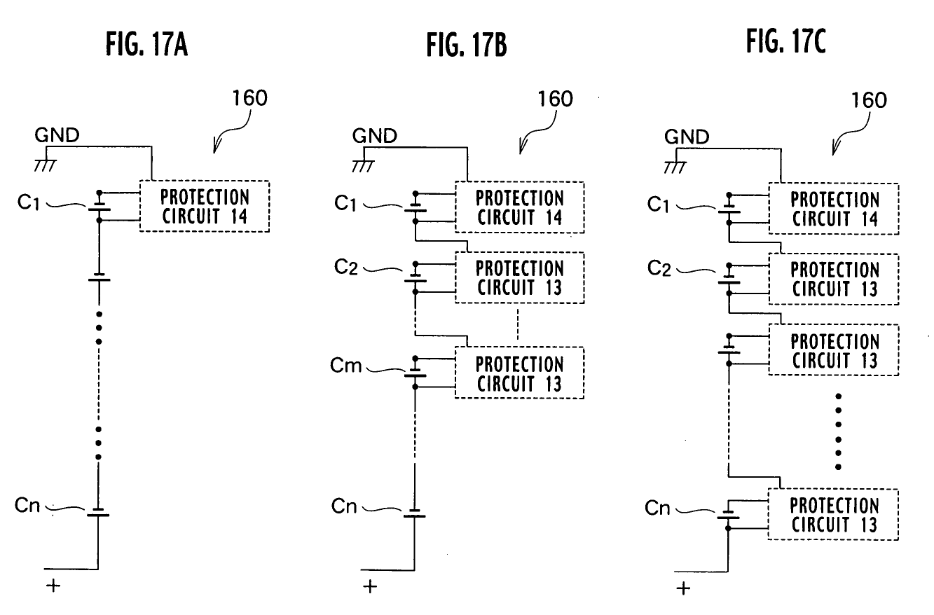

FIG. 17A through 17C show schematic drawings of fuel cell systems 160 according to a sixth embodiment of the present invention. According to FIG. 17A, the system can be configured so that the protection circuit 14 is connected to only one unit fuel cell C₁ at a negative end of unit fuel cells C₁, C₂, . . . Cₙ constituting the fuel cell stack. Alternatively, the system can be configured so that the protection circuit 14 is connected to the unit fuel cell C₁ and the protection circuits 13 are respectively connected to second to m-th unit fuel cells C₂, C₃, . . . Cₘ, among the unit fuel cells C₁, C₂, . . . Cₙ where m can be arbitrarily selected, as shown in FIG. 17B. Further alternatively, the system can be configured so that the protection circuit 14 is connected to the unit fuel cell C₁ and the protection circuits 13 are respectively connected to all the unit fuel cells C₂, C₃, . . . Cₙ except C₁ disposed at the negative end as shown in FIG. 17C.

Because any of the fuel cell systems 150 and 160 electrically separates any malfunctioning fuel cell from the fuel cell stack, the aforementioned monopolar type fuel cell stack shown in FIG. 11A can be applied thereto.

In any case of the fuel cell systems 110 through 160, in a case where a fuel cell stack constituting any of is set up in a manner that the MEAs therein are horizontally leveled, upper sides of the MEAs are preferably utilized as anodes and lower sides are preferably utilized as cathodes for better regulation of power generation. Of course, inverse utilization may be admissible for the power generation.

Furthermore, in such a case where the MEAs are horizontally leveled, fuel cells disposed at the upper part of the fuel cell stack may have larger possibility of malfunction because shortage of fuel supply tends to occur at the upper part. Therefore, a constitution in which the protection circuit is connected to only one unit fuel cell disposed at a top of the fuel cell stack is reasonable in view of cost and a product lifetime. Provided that the MEAs are horizontally leveled and the upper sides of the MEAs are utilized as anodes according to the preferable manner mentioned above, the top electrode of the stack is the negative electrode. Further provided that the negative electrode is grounded, the protection circuit 12 shown in FIG. 3 or the protection circuit 14 shown in FIG. 7 can be applied thereto.

The aforementioned protection circuit may be connected not to one unit fuel cell but across plural unit fuel cells. Moreover, the plural unit fuel cells may be electrically and all together separated from the fuel cell stack. In this case, a sequence of plural fuel cells may be separated so that voltage decrease is relatively large, however, it is advantageous in view of cost. In a case where the voltage decrease is permissible, such a constitution can be selected.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A protection circuit for a fuel cell stack having one or more fuel cells, the protection circuit comprising:
a detection unit detecting abnormality of a potential difference between positive and negative electrodes of at least one fuel cell of the fuel cell stack; and
a bypass unit forming bypass current path between the positive and negative electrodes, the bypass unit being operative when the detection unit detects the abnormality of the potential difference.

2. The protection circuit of claim 1, wherein:
the bypass unit comprises a switching device conducting an electric current when the detection unit detects the abnormality of the potential difference, the switching device being connected to the fuel cell in parallel.

3. The protection circuit of claim 2, wherein:
the fuel cell is selected from the fuel cells of the fuel cell stack excepting a grounded fuel cell and the bypass unit comprises a level conversion driver switching the switching device.

4. The protection circuit of claim 1, wherein:
the bypass unit comprises a first switching device cutting off an electric current when the detection unit detects the abnormality of the potential difference, the first switching device connected to the fuel cell in series, and a second switching device conducting an electric current when the detection unit detects the abnormality of the potential difference, the second switching device connected to a series of the fuel cell and the first switching device in parallel.

5. The protection circuit of claim 4, wherein:
the fuel cell is selected from the fuel cells of the fuel cell stack excepting a grounded fuel cell and the bypass unit comprises a level conversion driver switching the first switching device and the second switching device.

6. The protection circuit of claim 1, wherein:
the fuel cell is an unit fuel cell.

7. The protection circuit of claim 1, wherein:
the fuel cell comprises a series of plural unit fuel cells.

8. The protection circuit of claim 7, further comprises:
plural detection units respectively detecting abnormality of potential differences between the positive and negative electrodes of the plural unit fuel cells, the bypass unit being operative when at least one of the plural detection units detects the abnormality of the potential difference.

9. A fuel cell system comprising:
a fuel cell stack;
a detection unit detecting abnormality of a potential difference between positive and negative electrodes of at least one unit fuel cell of the fuel cell stack; and
a bypass unit forming bypass current path between the positive and negative electrodes, the bypass unit being operative when the detection unit detects the abnormality of the potential difference.

10. A fuel cell system comprising:
a fuel cell stack;
a detection unit detecting abnormality of a potential difference between both ends of at least one series of plural unit fuel cells, the plural unit fuel cells being connected in series and constituting a part of the fuel cell stack; and
a bypass unit forming bypass current path between the ends, the bypass unit being operative when the detection unit detects the abnormality of the potential difference.

11. A fuel cell system comprising:
a fuel cell stack;
plural detection units respectively detecting abnormality of potential differences between the positive and negative electrodes of plural unit fuel cells, the plural unit fuel cells being connected in series and constituting a part of the fuel cell stack; and
a bypass unit forming bypass current path between both ends of the series of the plural unit fuel cells, the bypass unit being operative when at least one of the plural detection units detects the abnormality of the potential difference.
